(19) United States
(12) Patent Application Publication
(10) Pub. No.: US 2024/0194992 A1
(43) Pub. Date: Jun. 13, 2024

(54) Battery Module and Method of Assembly Thereof

(71) Applicant: SUPERNAL, LLC, Washington, DC (US)

(72) Inventors: Kameron Buckhout, Albany, CA (US); Kevin Lewis, Freemont, CA (US); Loni Cariaga, Irvine, CA (US)

(21) Appl. No.: 18/233,634

(22) Filed: Aug. 14, 2023

Related U.S. Application Data
(60) Provisional application No. 63/431,315, filed on Dec. 8, 2022.

(51) Int. Cl. H01M 50/213; H01M 10/48; H01M 10/613; H01M 10/643; H01M 10/6551; H01M 10/6556; H01M 10/658; H01M 50/342; H01M 50/367; H01M 50/505; H01M 50/569

(52) U.S. Cl. CPC H01M 50/213; H01M 10/482; H01M 10/486; H01M 10/613; H01M 10/643; H01M 10/6551; H01M 10/6556; H01M 10/658; H01M 50/3425; H01M 50/367; H01M 50/505; H01M 50/569

(57) ABSTRACT

An example battery module includes a housing; a cell mounting plate mounted to the housing such that the housing and the cell mounting plate mounted thereto form an enclosure; a plurality of battery cells mounted and adhered to the cell mounting plate within the enclosure; a temperature sensing structure mounted within the enclosure and having one or more branches extending between respective battery cells of the plurality of battery cells; a current collector mounted to the plurality of battery cells, opposite the cell mounting plate; and a cover mounted to the housing such that a venting chamber is formed between the plurality of battery cells and an interior surface of the cover, wherein gas generated by the respective battery cells of the plurality of battery cells is provided to the venting chamber.

### CROSS-REFERENCE TO RELATED APPLICATION

The present application claims priority to U.S. Provisional Application No. 63/431,315 filed Dec. 8, 2022, the contents of which are hereby incorporated by reference in its entirety.

### BACKGROUND

Batteries are used in many applications including consumer electronics, electric vehicles, robots, and power-grid storage. A battery goes through many cycles of charging and discharging throughout its life.

An example battery includes several battery modules, each battery module having a respective plurality of battery cells. The battery may heat up during charging, and particularly during fast charging rates (e.g., high coulomb rates). Further, during periods of high demand on the battery, the battery may heat up substantially.

High temperatures reduce the lifespan of the battery, and may lead to an increase in the risk of a thermal runaway event (e.g., an event where a strong exothermic chain reaction occurs within a battery cell, and the battery cell enters an uncontrollable, self-heating state that could result in ejection of gas, shrapnel, and/or particulates). It may thus be desirable to configure the battery with thermal protection features.

It is with respect to these and other considerations that the disclosure made herein is presented.

### SUMMARY

The present disclosure describes implementations that relate to a battery module and method of assembly thereof.

In a first example implementation, the present disclosure describes a battery module. The battery module includes: a housing; a cell mounting plate mounted to the housing such that the housing and the cell mounting plate mounted thereto form an enclosure; a plurality of battery cells mounted and adhered to the cell mounting plate within the enclosure; a temperature sensing structure mounted within the enclosure and having one or more branches extending between respective battery cells of the plurality of battery cells; a current collector mounted to the plurality of battery cells, opposite the cell mounting plate; and a cover mounted to the housing such that a venting chamber is formed between the plurality of battery cells and an interior surface of the cover, wherein gas generated by the respective battery cells of the plurality of battery cells is provided to the venting chamber.

In a second example implementation, the present disclosure describes a method of assembling the battery module of the first example implementation.

The foregoing summary is illustrative only and is not intended to be in any way limiting. In addition to the illustrative aspects, implementations, and features described above, further aspects, implementations, and features will become apparent by reference to the drawings and the following detailed description.

### BRIEF DESCRIPTION OF THE FIGURES

FIG. 1 illustrates an exploded perspective view of a battery module, according to exemplary embodiments of the present invention.

FIG. 2 illustrates an exploded perspective view of an enclosure of the battery module of FIG. 1, according to exemplary embodiments of the present invention.

FIG. 3 illustrates a perspective view of a cell mounting plate having fins disposed about a perimeter thereof, according to exemplary embodiments of the present invention.

FIG. 4 illustrates a perspective view of a partial assembly of the battery module of FIG. 1 showing an enclosure with a cell mounting plate mounted to a housing and electric conductors being mounted to the housing, according to exemplary embodiments of the present invention.

FIG. 5 illustrates a perspective view of a partial assembly of the battery module of FIG. 1 showing an enclosure with electric conductors mounted to a housing, according to exemplary embodiments of the present invention.

FIG. 6 illustrates a perspective view of a partial assembly of the battery module of FIG. 1 showing mounting of battery cells of a cell array to a cell mounting plate, according to exemplary embodiments of the present invention.

FIG. 7 illustrates a perspective view of a cylindrical cell, according to exemplary embodiments of the present invention.

FIG. 8 illustrates a perspective view of a partial assembly of the battery module of FIG. 1 showing mounting of a temperature sensing structure within a cell array, according to exemplary embodiments of the present invention.

FIG. 9 illustrates a perspective view of a partial assembly of the battery module of FIG. 1 showing mounting of a voltage sensor, according to exemplary embodiments of the present invention.

FIG. 10 illustrates a perspective view of a partial assembly of the battery module of FIG. 1 showing mounting of a cell holder, according to exemplary embodiments of the present invention

FIG. 11 illustrates a perspective view of a partial assembly of the battery module of FIG. 1 showing mounting of a current collector, according to exemplary embodiments of the present invention.

FIG. 12 illustrates a perspective view of a partial assembly of the battery module of FIG. 1 showing mounting of battery controller to a housing, according to exemplary embodiments of the present invention.

FIG. 13 illustrates a perspective exploded view of a partial assembly of the battery module of FIG. 1 showing mounting of a coldplate to a housing, according to exemplary embodiments of the present invention.

FIG. 14 illustrates a perspective view of a partial assembly of the battery module of FIG. 1 showing mounting of a cover to an enclosure, according to exemplary embodiments of the present invention.

FIG. 15 illustrates a perspective exploded view of the cover of FIG. 14, according to exemplary embodiments of the present invention.

FIG. 16 illustrates a perspective view of the battery module of FIG. 1 in an assembled state, according to exemplary embodiments of the present invention.

FIG. 17A illustrates a cross-sectional elevational view of the battery module shown in FIG. 16, according to exemplary embodiments of the present invention.

FIG. 17B illustrates a partial cross-sectional top view of the battery module shown in FIG. 16, according to exemplary embodiments of the present invention.

FIG. 18 is a flowchart of a method for assembling the battery module of FIG. 1, according to exemplary embodiments of the present invention.

### DETAILED DESCRIPTION

Disclosed herein are systems, assemblies, and methods for a battery module. The disclosed systems, assemblies, and methods are applicable to any type of battery (e.g., lithium-ion batteries, batteries having silicon-alloy/graphite blend anode combined with a nickel rich lithium nickel manganese cobalt oxide as cathode, lithium metal batteries, etc.).

The disclosed system may be utilized in any device or application that uses batteries. For example, the batteries may be used to power electric motors of a vehicle, including but not limited to a ground vehicle (i.e., an automobile), a sea vehicle (such as a boat), or a flying craft (such as an aerial, floating, soaring, hovering, airborne, aeronautical aircraft, airplane, plane, spacecraft, a helicopter, an airship, or an unmanned aerial vehicle, a vertical take-off and landing (VTOL) craft, or a drone). The disclosed embodiments of the present invention may be used in any of these applications in order to obtain advantages such as reducing weight of the battery, improving mechanical strength of the battery, improving fire protection of the battery (e.g., active functional safety and/or predictive functional safety), reducing the likelihood of a thermal runaway event, and/or maintaining robust packaging of the battery.

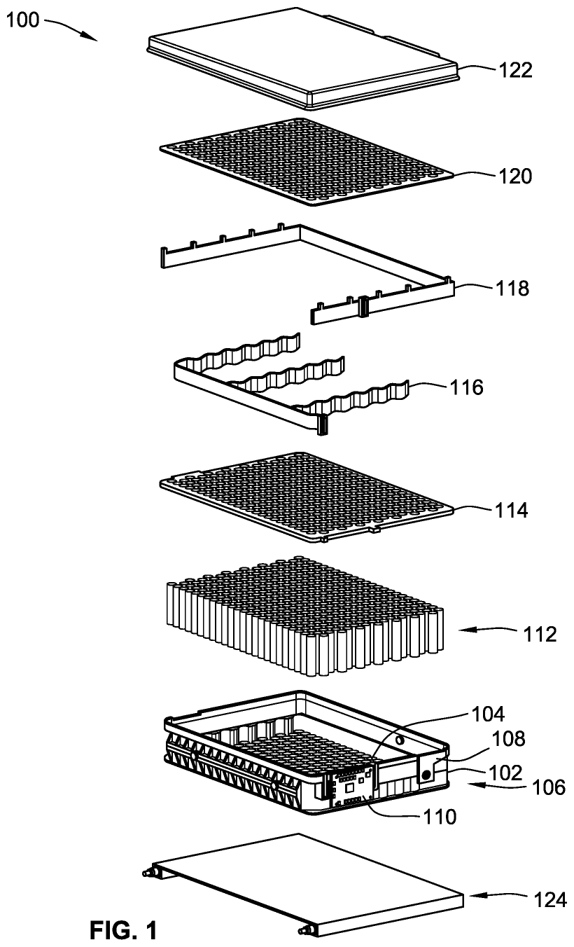

FIG. 1 illustrates an exploded perspective view of a battery module 100, according to exemplary embodiments of the present invention. The battery module 100 can be one of a plurality of battery modules that form a battery used in a vehicle, for example.

In some embodiments, the battery module 100 may include a housing 102. The battery module 100 may also include a cell mounting plate 104 mounted to the housing 102 such that the housing 102 and the cell mounting plate 104 mounted thereto form an enclosure 106.

In some embodiments, the battery module 100 may include a positive and negative electric conductor such as electric conductor 108 mounted to the housing 102. The electric conductor 108 can take several forms. For example, the electric conductor 108 can be a bus bar or a metal strip that is used to connect the positive and negative terminals of the battery module 100 to an external consumer such as an electric motor. The electric conductor 108 can be made of copper or aluminum, for example, as these materials have high conductivity and are able to handle high currents without overheating.

In some embodiments, the battery module 100 may also include a module management unit (MMU) or battery controller 110. In an example, the battery controller 110 is mounted to the housing 102 as shown in FIG. 1.

In some embodiments, the battery controller 110 may include one or more processors or microprocessors and may include data storage (e.g., memory, transitory computer-readable medium, non-transitory computer-readable medium, etc.). The data storage may have stored thereon instructions that, when executed by the one or more processors of the battery controller 110, cause the battery controller 110 to perform operations described herein. The battery controller 110 can also include a communication interface (wires or wireless) that facilitates communication with external computing devices, servers, or the cloud.

In an example, the battery controller 110 may be configured as a printed circuit board (PCB). A PCB mechanically supports and electrically connects electronic components (e.g., microprocessors, integrated chips, capacitors, resistors, etc.) using conductive tracks, pads, and other features etched from one or more sheet layers of copper laminate onto and/or between sheet layers of a nonconductive substrate. Components are generally soldered onto the PCB to both electrically connect and mechanically fasten them to it.

In some embodiments, the battery controller 110 may be configured as an electronic regulator that monitors and controls the charging and discharging of the battery module 100, for example. In an example, the battery controller 110 may be configured to measure voltages of the battery module 100 and stop charging them when a desired voltage is reached.

In some embodiments, the battery controller 110 may also monitor and control parameters of the battery module 100. For example, the battery controller 110 may monitor and control battery module voltage or cell voltage, charging and discharge rates of the battery module 100, etc. In an example, the battery controller 110 may control the power flow to and from the battery module 100 based on power demand from the various consumers (e.g., electric motors).

In some embodiments, the battery controller 110 may also perform operations associated with predicting future condition of the battery module 100 and whether a thermal runaway event might occur, for example. The battery controller 110 may also provide information indicative of a state of the battery module 100 to external devices (e.g., external computing devices, servers, or the cloud) and receive instructions and information from such external devices.

In some embodiments, the battery module 100 may further include a plurality of battery cells configured as a cell array 112. In an example, the battery cells of the cell array 112 may be cylindrical in shape as depicted in FIG. 1. The battery cells of the cell array 112 are mounted and adhered to the cell mounting plate 104 within the enclosure 106.

In some embodiments, the battery module 100 may further include a cell holder 114 mounted to (e.g., atop) the battery cells if the cell array 112. As depicted in FIG. 1, the cell holder 114 may be mounted opposite the cell mounting plate 104.

In some embodiments, the battery module 100 may also include a temperature sensing structure 116 mounted within the enclosure 106 and having one or more branches extending between battery cells of the plurality of battery cells of the cell array 112. The temperature sensing structure 116 can be configured to provide sensor information to the battery controller 110 indicative of temperature level within the cell array 112.

In some embodiments, the battery module 100 may also include a voltage sensor 118 configured as a frame mounted to or within the cell array 112. The voltage sensor 118 can be configured to provide sensor information to the battery controller 110 indicative of a voltage level of the cell array 112.

In some embodiments, the battery module 100 may also include a current collector 120 mounted to the battery cells of the cell array 112, opposite the cell mounting plate 104. The current collector 120 may be configured to receive electric current generated by the battery cells and provide the current to the electric conductors (e.g., the electric conductor 108) to be provided to an external power consumer (e.g., an electric motor). The cell holder 114 may be configured to be interposed between the current collector 120 and the cell array 112.

In some embodiments, the battery module 100 may further include a cover 122 mounted to the housing 102. The cover 122 may be configured to complete or lock the enclosure 106 and protect the components of the battery module 100 within the housing 102.

During operation of the battery module 100, as it generates electric power, it also generates heat. Cooling the battery module 100 may improve the reliability and lifespan of the battery module 100.

In one example, the battery module 100 can in air cooled. In this example, the cell mounting plate 104 may include fins disposed about its perimeter to facilitate heat transfer.

In another example, the battery module 100 can be liquid cooled. In this example, the battery module 100 may include a coldplate 124. The coldplate can be mounted at a bottom of the housing 102, for example. The coldplate 124 can also be referred to as a liquid-cooled plate, and is configured to transfer heat away from the cell array 112, which generates heat during operation of the battery module 100.

The coldplate 124 may include a flat plate that is configured to be in direct or indirect contact (e.g., via the cell mounting plate 104) with the cell array 112 that generates heat. The flat plate may be made of materials with high thermal conductivity, such as copper or aluminum. As described in more details below, a liquid coolant, such as water or a specialized fluid, can be pumped through channels within the coldplate 124 to absorb the heat generated by the cell array 112. The heated coolant may then be carried away from the coldplate 124 to a heat exchanger or radiator where it is cooled before being recirculated back to the coldplate 124. This process may help regulate the temperature of the battery module 100.

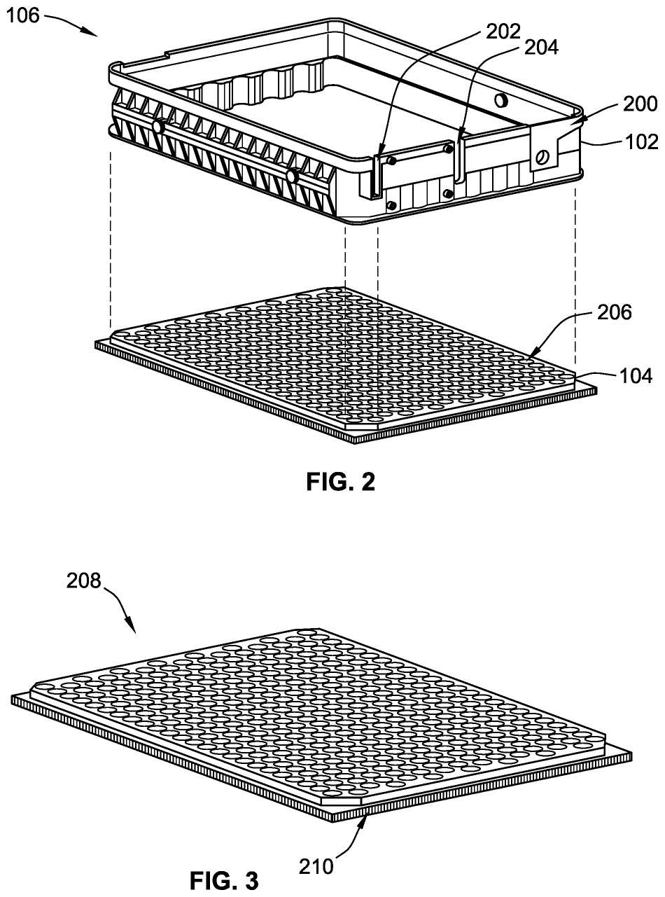

Steps of assembling the battery module 100 and details related to each of the components of the battery module 100 are described next with respect to FIGS. 2-16.

FIG. 2 illustrates an exploded perspective view of the enclosure 106, according to exemplary embodiments of the present invention. As depicted, the housing 102 may be configured as a generally rectangular prism having four side walls, while having an open top and bottom to allow components of the battery module 100 to be mounted within the housing 102.

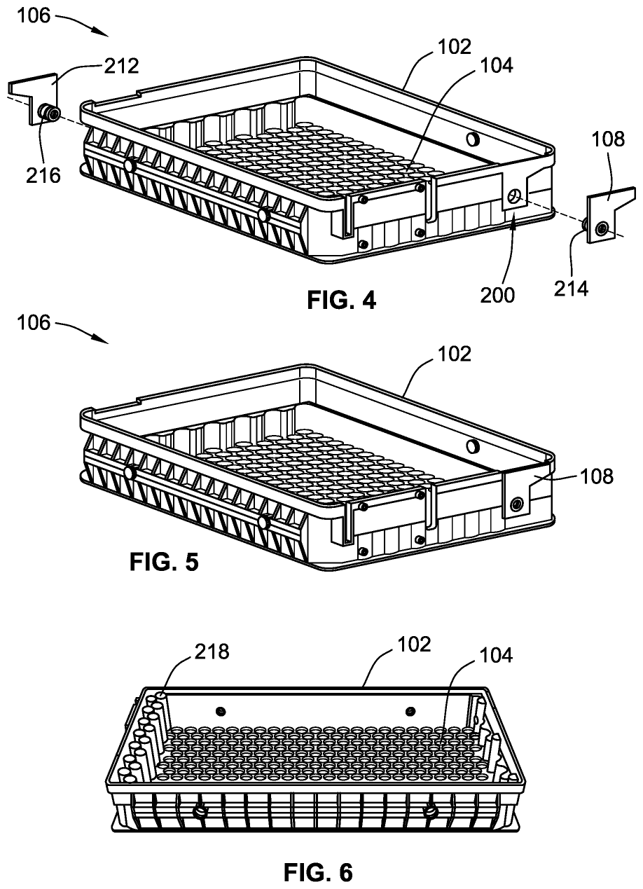

In some embodiments, the housing 102 may have a depression 200 on one of its sides configured to receive the electric conductor 108 therein. The housing 102 may also include another depression on the other side (opposite the side having the depression 200) to accommodate a second electric conductor (see electric conductor 212 in FIG. 4).

In some embodiments, the housing 102 may also include a first slot 202 and a second slot 204. The slots 202, 204 may be configured to accommodate electric connectors of the temperature sensing structure 116 and the voltage sensor 118 as described below. The housing 102 can have other features such as threaded holes that can facilitate mounting the battery controller 110 to the housing 102, for example.

In an example, the housing 102 can be made of a composite material capable of withstanding high temperatures associated with operating the battery module 100. The composite material can also render the housing 102 having a light weight. An example composite material for the housing 102 includes low combustibility carbon fiber reinforced composite. For instance, fibers of such reinforced composite can be vertically aligned for thermal conductivity in the vertical direction to balance mechanical performance, thermal conductivity, and weight. In an example, during manufacturing of the housing 102, grain structure of the composite material of the housing 102 may be formed in a way to direct the thermal energy down towards the cell mounting plate 104.

In some embodiments, the cell mounting plate 104 may be configured to be mounted to a bottom of the housing 102 to close the housing 102 on one end (e.g., bottom end). As an example for illustration, the cell mounting plate 104 can be made of aluminum coated by a dielectric material to electrically insulate the battery cells of the cell array 112 from each other and to protect the battery cells from static electricity or other electrical disturbances. Examples of such a dielectric material may include glass, ceramic, rubber, or plastic.

The cell mounting plate 104 may have a plurality of depressions that match a shape of the battery cells and configured to retain the battery cells laterally in the cell mounting plate 104. For example, the cell mounting plate 104 may include cylindrical or conical depressions such as depression 206 that match the cylindrical shape of the battery cells of the cell array 112. The depressions of the cell mounting plate 104 may have a slight taper to facilitate inserting the battery cells into the depressions. However, in an example, the depressions have dimensions that match respective dimensions of the battery cells such that the battery cells are slightly press fitting into the depressions to be retained to the cell mounting plate 104.

As mentioned above with respect to FIG. 1, the battery module 100 can be liquid cooled, and may thus include the coldplate 124 interfacing with the cell mounting plate 104 to transfer heat generated by the battery cells away from the battery module 100. In other examples, the battery module 100 is air cooled.

FIG. 3 illustrates a perspective view of a cell mounting plate 208 having fins 210 disposed about a perimeter thereof, according to exemplary embodiments of the present invention. In the example where the battery module 100 is air cooled, the cell mounting plate 104 can be swapped or replaced with the cell mounting plate 208.

In some embodiments, the fins 210 of the cell mounting plate 208 may be configured as cooling fins that rely on conduction to diffuse the heat away from the cell mounting plate 208 and the battery cells mounted thereto. The fins 210 may be configured to increase the surface area of the cell mounting plate 208 for enhanced heat transfer.

FIG. 4 illustrates a perspective view of a partial assembly of the battery module 100 showing the enclosure 106 with the cell mounting plate 104 mounted to the housing 102 and electric conductors being mounted to the housing 102, according to exemplary embodiments of the present invention. As shown, the electric conductor 108 can be mounted within the depression 200 formed on the exterior surface of the housing 102. Another electric conductor 212 can be mounted on the other side of the housing 102 in a respective depression.

In some embodiments, the electric conductors 108, 212 may have mounting features (e.g., fasteners) that facilitate mounting them to the housing 102. For example, as shown, the electric conductor 108 can have a cylindrical component 214 mounted thereto, and the electric conductor 212 can also have a cylindrical component 216 mounted thereto. The cylindrical components 214, 216 can be inserted into respective holes formed in the housing 102 to attach the electric conductors 108, 212 to the housing 102.

FIG. 5 illustrates a perspective view of a partial assembly of the battery module 100 showing the enclosure 106 with the electric conductors 108, 212 mounted to the housing 102, according to exemplary embodiments of the present invention.

FIG. 6 illustrates a perspective view of a partial assembly of the battery module 100 showing mounting of battery cells 218 of the cell array 112 to the cell mounting plate 104, according to exemplary embodiments of the present invention. As an example for illustration, the cell array 112 can have a “10S 36P” configuration. In this configuration, “10S” indicates that ten battery cells are connected in series (e.g., the positive terminal of one cell is connected to the negative terminal of the next cell, resulting a total voltage output equal to the sum of the voltage of each individual cell).

On the other hand, “36P” indicates that a thirty six set of ten cells are connected in parallel. Each set of ten cells is connected positive to positive and negative to negative, resulting in a combined current output equal to the sum of the current output of each individual cell. As such, in this example, the cell array 112 can include a total of 360 cells with a high voltage output and high current capacity, making it suitable for high-power applications such as electric vehicles, VTOL crafts, or renewable energy storage systems. As depicted in FIG. 6, in this example embodiment, the battery cells 218 of the cell array 112 can be cylindrical cells.

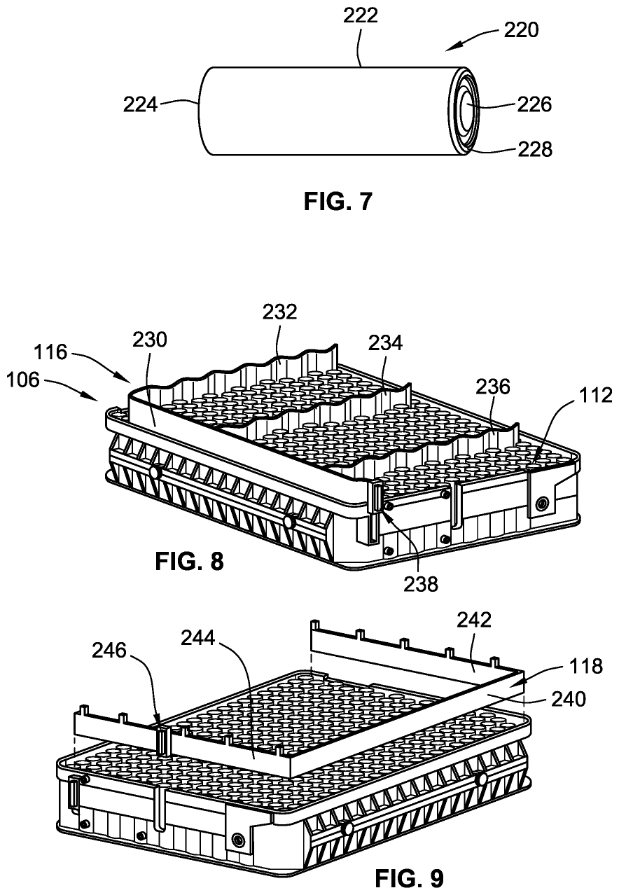

FIG. 7 illustrates a perspective view of a cylindrical cell 220, according to exemplary embodiments of the present invention. As an example for illustration, the battery cells of the cell array 112, such as the cylindrical cell 220, may be a “21700 5 Ah” battery cell, which is a type of rechargeable lithium-ion battery cell that has cell body 222 having a diameter of 21 millimeter (mm), a length of 70 mm, and a capacity of 5 ampere-hours (Ah). In other words, the cylindrical cell 220 can generate a current of 5 amperes for one hour, or 1 ampere for five hours, before it is fully discharged.

A 21700 battery cell may be characterized by a higher energy density (e.g., it can store more energy per unit volume or weight). It may also have a lower internal resistance, thereby allowing the discharge of more current without overheating. It may also be characterized by a longer cycle life, e.g., it can be charged and discharged more times before they start to degrade. This configuration is an example for illustration, and other configurations, cell types, or cell numbers can be used and are contemplated herein. For instance, prismatic cells could be used instead of cylindrical cells.

In some embodiments, the cylindrical cell 200 may have a positive terminal end 224 that is mounted and adhered to the cell mounting plate 104. For example, a thermally conductive dielectric adhesive material could be used to adhere and mount the positive terminal end 224 of respective cells of the cell array 112 to the cell mounting plate 104. An example of a thermally conductive dielectric adhesive is silicone adhesive. Silicone adhesives can conduct heat while also being an electrical insulator. The thermally conductive properties of silicone adhesives may help prevention of overheating of the battery cells, while the dielectric properties ensure that there is no electrical conductivity between the battery cells (e.g., preventing short circuits).

In some embodiments, a negative terminal end 226 of the cylindrical cell 220 may have a shoulder 228. As described below, the cell holder 114 of the battery module 100 may be mounted on the respective shoulders of the battery cells.

In an example, as the battery cells are being mounted to the cell mounting plate 104 or upon completion of mounting all the battery cells, the cell array 112 can be potted with a structural potting disposed between the respective battery cells. In other words, a potting material is applied in spaces between the respective battery cells. The potting material can absorb heat and vibration, and enhance mechanical robustness of the cell array 112. With this configuration, lighter materials may be used for the battery module structures (e.g., for the housing 102), while maintaining mechanical robustness of the battery module 100.

Upon completion or during mounting the battery cells of the cell array 112, various sensors may be mounted to the cell array 112. For example, the temperature sensing structure 116 and the voltage sensor 118 can be mounted within the enclosure 106.

FIG. 8 illustrates a perspective view of a partial assembly of the battery module 100 showing mounting of the temperature sensing structure 116 within the cell array 112, according to exemplary embodiments of the present invention. As depicted in FIG. 8, the temperature sensing structure 116 may have a strip or base 230 from which several braches such as branch 232, branch 234, and branch 236 project from the base 230. However, more or fewer branches could be used.

The branches 232, 234, 236 can also be referred to as battery holders or brackets. As depicted in FIG. 8, each branch of the branches 232, 234, 236 has a zigzag shape and lobe design (e.g., each branch has a plurality of lobes that face in opposite directions) to help accommodating the cylindrical battery cells and securely holding/retaining the batteries cells in place.

In some embodiments, the temperature sensing structure 116 may be made of a thermally conductive material to sense temperature level at one or more points within the cell array 112. The base 230 may be connected to an electric connector 238 configured to be disposed in the second slot 204 formed in the housing 102 as shown in FIG. 2. The battery controller 110 may be mounted to the housing 102 such that the controller is electrically connected or coupled to the electric connector 238 to receive sensor information indicative of a temperature of the cell array 112 from the temperature sensing structure 116.

FIG. 9 illustrates a perspective view of a partial assembly of the battery module 100 showing mounting of the voltage sensor 118, according to exemplary embodiments of the present invention. The voltage sensor 118 may be mounted inside the cell array 112 similar to the temperature sensing structure 116.

As depicted in FIG. 9, the voltage sensor 118 may be U-shaped (e.g., shaped like a yoke) and has a base 240, a first side 242 at one end of the base 240, and a second side 244 at the other end of the base 240. The second side 244 may be connected to an electric connector 246 configured to be disposed in the first slot 202 formed in the housing 102 as shown in FIG. 2.

In an example, the voltage sensor 118 can be configured to be electrically coupled to the negative and positive terminals of the cell array 112, and thus provides an indication of the potential difference between the terminals. For example, the voltage sensor 118 may be electrically coupled to the current collector 120, the current collector 120 may be electrically coupled to the cell array 112, and the voltage sensor 118 can be configured to measure the voltage level of the cell array 112 via the electrical connection between the current collector 120 and the cell array 112. As such, the voltage sensor 118 may be configured to generate a signal indicative of the voltage level of the cell array 112.

In some embodiments, the battery controller 110 may be mounted to the housing 102 such that the controller is electrically connected or coupled to the electric connector 246 to receive sensor information indicative of a voltage of the cell array 112 from the voltage sensor 118. This way, the battery controller 110 can monitor and control charging and discharging the battery module 100 to maintain its optimal performance and lifespan, for example.

With the configuration shown in FIGS. 8-9, the temperature sensing structure 116 and the voltage sensor 118 may be embedded within the cell array 112 and the battery module 100 with the electric connectors 238, 246 connecting them respectively to the battery controller 110 (which is externally-mounted). As such, wires associated with the temperature sensing structure 116 and the voltage sensor 118 are enclosed and are less vulnerable to chaffing or damage.

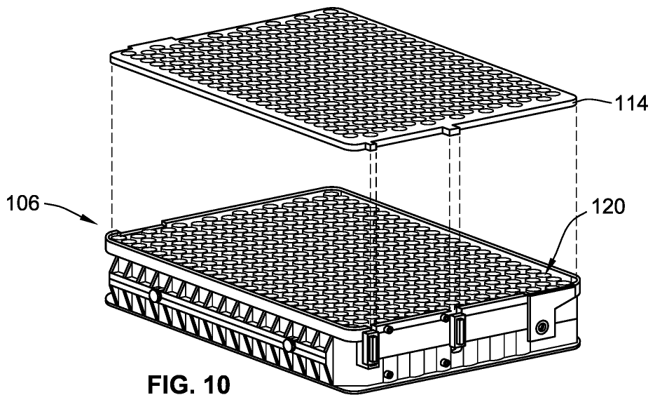

FIG. 10 illustrates a perspective view of a partial assembly of the battery module 100 showing mounting of the cell holder 114, according to exemplary embodiments of the present invention. After the temperature sensing structure 116 and the voltage sensor 118 are mounted to or within the cell array 112, the cell holder 114 may be mounted atop the cell array 112.

The cell holder 114 may be formed generally as a plate configured to be mounted to the respective battery cells of the cell array 112 such that the cell holder 114 rests on respective shoulders, e.g., the shoulder 228 of the cylindrical cell 220 shown in FIG. 7, at the negative terminal end of the battery cells. In an example, a structural adhesive is applied to the interior surfaces of the housing 102 and the shoulders at the negative terminals of the battery cells. To facilitate mounting the cell holder 114 to the cell array 112.

An example structural adhesive is epoxy, which can include a two-part adhesive that is made up of a resin and a hardener. When mixed together in the correct proportions, the two components chemically react to form a strong, durable bond to affix the cell holder 114 within the housing 102 atop the cell array 112. In an example, the partial assembly shown in FIG. 10 is left in a manufacturing fixture for a particular period of time to allow such adhesive to cure before mounting the current collector 120.

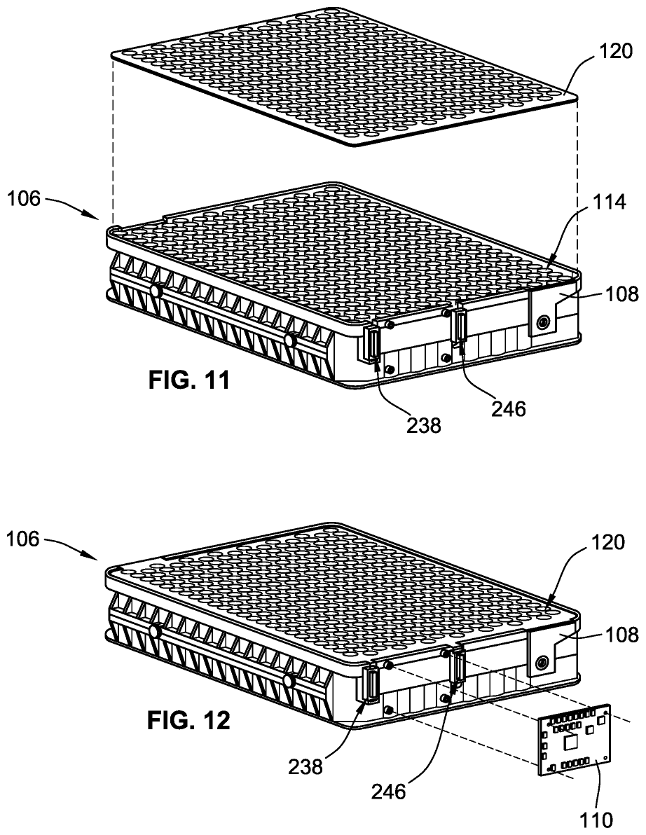

FIG. 11 illustrates a perspective view of a partial assembly of the battery module 100 showing mounting of the current collector 120, according to exemplary embodiments of the present invention. As shown in FIG. 1, 11, the current collector 120 may be formed generally as a perforated plate having holes corresponding to the respective battery cells of the cell array 112. The current collector 120 may be configured to transfer electrons between the electrodes of the battery cells and an external circuit (e.g., power electronics of an electric motor) via the electric conductors 108, 212, for example. The current collector 120 can be made of a conductive material, such as copper or aluminum.

In an example, the current collector 120 includes a plurality of layers, such as five layers. Three layers are isolation layers that are interposed between two current carrying layers. The layers can be wirebonded or laser-welded as examples.

FIG. 12 illustrates a perspective view of a partial assembly of the battery module 100 showing mounting of the battery controller 110 to the housing 102, according to exemplary embodiments of the present invention. As shown in FIG. 1, 12, the battery controller 110 may be mounted between the electrical connectors 238, 246 such that the battery controller 110 is electrically coupled to the electrical connectors 238, 246. This way, the battery controller 110 may receive sensor information from the temperature sensing structure 116 and the voltage sensor 118.

In the example, where the battery module is liquid cooled, the coldplate 124 can be mounted next.

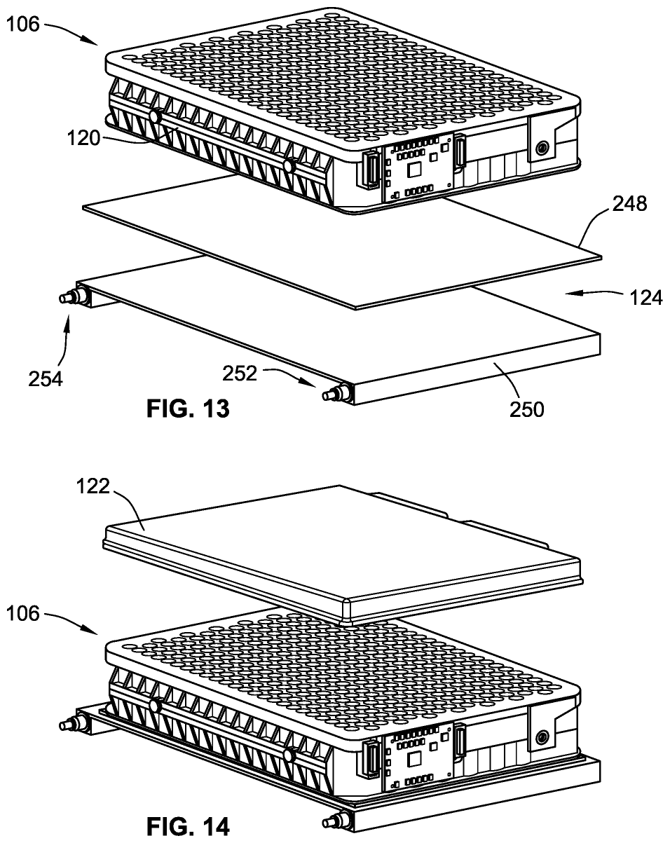

FIG. 13 illustrates a perspective exploded view of a partial assembly of the battery module 100 showing mounting of the coldplate 124 to the housing 102, according to exemplary embodiments of the present invention. In an example, the coldplate 124 can include a flat plate 248 made from a thermally conductive material such as aluminum or copper. In an example, the flat plate 248 can be coupled to the cell mounting plate 104 via a thermally conductive interface material such as a thermal paste or pad.

The coldplate 124 may also include a coolant plate 250 that has a depression in which the flat plate 248 is disposed. The coolant plate 250 can have channels formed therein in which coolant fluid, such as water or a specialized fluid, circulates. For example, the coolant plate 250 can have a first port 252 (e.g., an inlet port) and a second port 254 (e.g., an outlet port). The coolant plate 250 can have one or more quick-connect fittings mounted to the coolant plate 250 at the first port 252 and the second port 254 to facilitate connecting coolant fluid lines to and from a heat exchanger. A pump may facilitate circulating fluid between the heat exchanger and the coolant plate 250.

Coolant fluid received, e.g., via the first port 252, flows through channels or passages within the coolant plate 250 to absorb the heat generated by the cell array 112 and conducted to the coolant plate via the flat plate 248. The heated coolant may then be discharged from the second port 254 and carried away from the coolant plate 250 and into a heat exchanger or radiator where it is cooled before being recirculated back to the coolant plate 250. This process may help regulate the temperature of the battery module 100.

To complete the assembly process of the battery module 100, the cover 122 may be mounted to the housing 102. In addition to being a protective cover for the battery module 100, the cover 122 may also be configured to operate as a vent in the case that pressure level within the battery module 100 exceeds a threshold value.

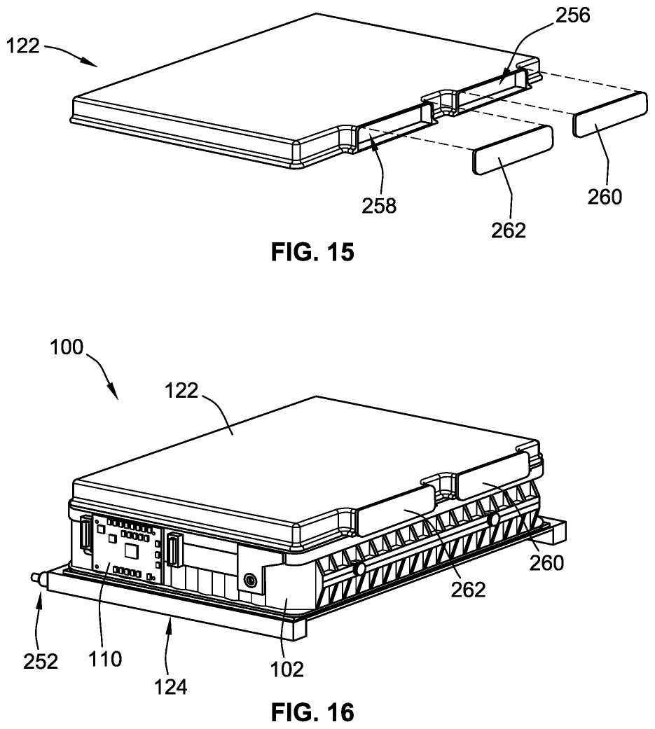

FIG. 14 illustrates a perspective view of a partial assembly of the battery module 100 showing mounting the cover 122 to the enclosure 106, according to exemplary embodiments of the present invention, and FIG. 15 illustrates a perspective exploded view of the cover 122, according to exemplary embodiments of the present invention. As shown, in FIG. 15, the cover 122 can have one or more openings or windows such as window 256 and window 258. The windows 256, 258 may be covered by respective burst plates such as burst plate 260 and burst plate 262.

In some embodiments, the burst plates 260, 262 may be configured as pressure safety devices that can relieve pressure within the battery module 100 if the pressure reaches a particular level. In an example, each of the burst plates 260, 262 can be configured as a thin metal (e.g., stainless steel, nickel alloys, etc.) or composite membrane that is placed in the cover 122 such that the membrane ruptures at a specific pressure level.

The shape of the windows and burst members may vary. For example, circular windows and burst discs could be used. As such, “window” is used herein to encompass any opening shape and “burst plate” is used to encompass any shape/type of a burst member.

During operation of the battery module 100, heat is generated, which might cause air or gas inside the battery module 100 to expand. The burst plates 260 are configured to allow gas within the battery module 100 to be released if the pressure level exceeds a threshold value, e.g., 2 pounds per square inch (psi) to protect the battery module 100 from over-pressurization. This configuration may also prevent propagation of a thermal event in one battery cell to neighboring cells.

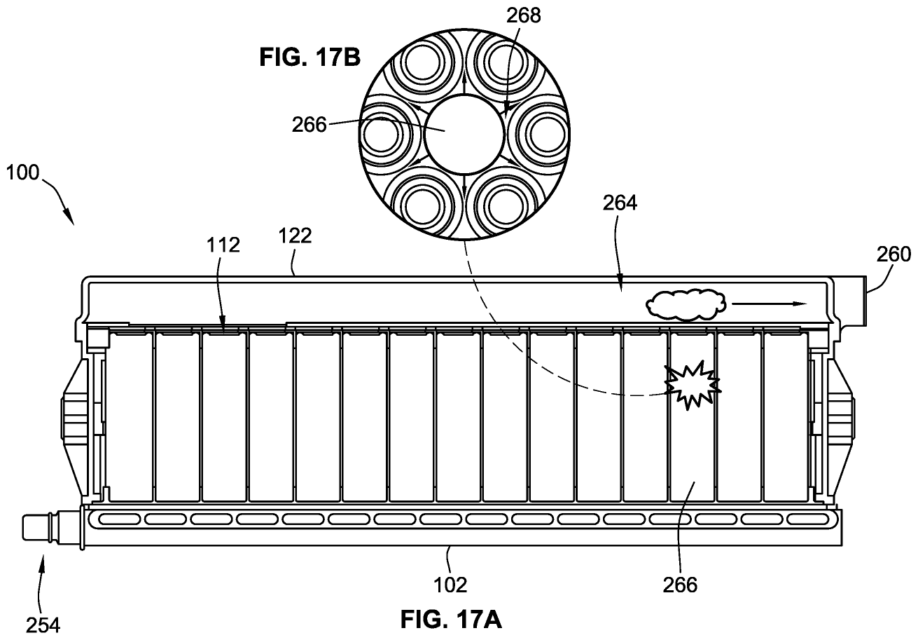

FIG. 16 illustrates a perspective view of the battery module 100 in an assembled state, FIG. 17A illustrates a cross-sectional elevational view of the battery module 100 shown in FIG. 16, and FIG. 17B illustrates a partial cross-sectional top view of the battery module 100 shown in FIG. 16, according to exemplary embodiments of the present invention. As depicted in FIG. 17A, the cover 122 may be mounted to the housing 102 such that a venting chamber 264 is formed between the battery cells of the cell array 112 and an interior surface of the cover 122.

During operation, if air or gas within the battery module 100 is heated, causing pressure level within the venting chamber 264 to increase to a threshold value (e.g., 2 psi), the burst plates 260, 262 rupture and allow the air/gas to escape, thereby relieving pressure and preventing potential damage or explosion.

Further, if a failure or damage occur in one battery cell such as the battery cell 266 (e.g., due to a thermal runaway event), and gas is generated within the battery module 100, such gas is provided to the venting chamber 264. Once pressure level exceeds the threshold value of the burst plates 260, 262, they rupture to relieve pressure inside the venting chamber 264. This way, damage and heat from the battery cell 266 might not propagate to the neighboring battery cells.

Further, as mentioned above and as shown in FIG. 17B, the battery module 100 includes potting material 268 disposed between the battery cells of the cell array 112. In addition to enhancing cell strength and mechanical robustness, and reducing cell tendency to side rupture, the potting material 268 may also reduce radial heat propagation from one cell to neighboring cells. Thus, a thermal runaway event in one cell may be contained and prevented from damaging other cells.

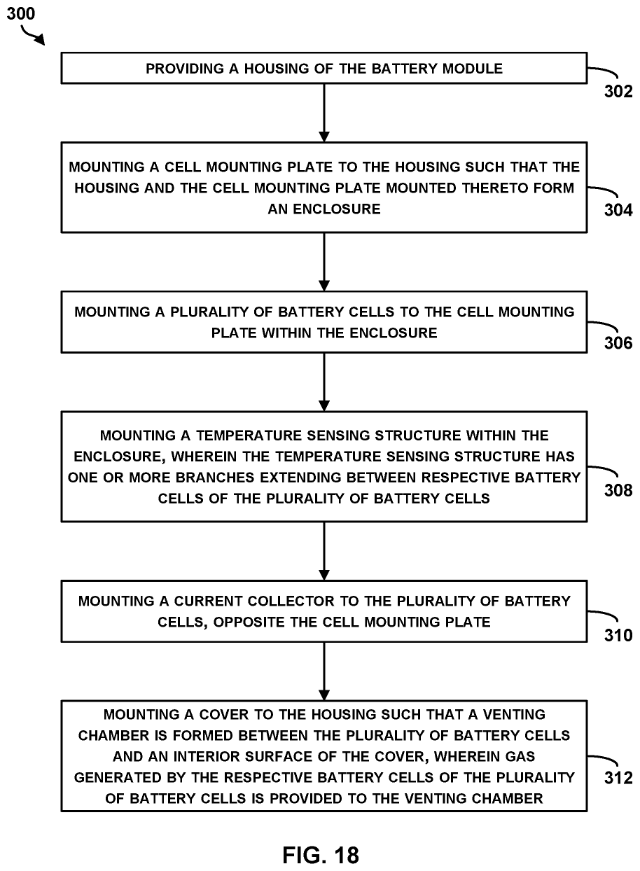

FIG. 18 is a flowchart of a method 300 for assembling the battery module 100, according to exemplary embodiments of the present invention. The method 300 may include one or more operations, functions, or actions as illustrated by one or more of steps 302-312.

Although the steps are illustrated in a sequential order, these steps may also be performed in parallel, and/or in a different order than those described herein. Also, the various steps may be combined into fewer steps, divided into additional steps, and/or removed based upon the desired implementation. It should be understood that for this and other processes and methods disclosed herein, flowcharts show functionality and operation of one possible implementation of present examples. Alternative implementations are included within the scope of the examples of the present disclosure in which functions may be executed out of order from that shown or discussed, including substantially concurrent or in reverse order, depending on the functionality involved, as would be understood by those reasonably skilled in the art

At a step 302, the method 300 may include providing the housing 102 of the battery module 100. The term “providing” as used herein, and for example with regard to the housing 102 or other components, includes any action to make the housing 102 or any other component available for use, such as bringing the housing 102 or other components to an apparatus or to a work environment (e.g., a manufacturing fixture) for further processing (e.g., mounting other components, etc.).

At a step 304, the method 300 may also include mounting the cell mounting plate 104 to the housing 102 such that the housing 102 and the cell mounting plate 104 mounted thereto form the enclosure 106.

At a step 306, the method 300 may also include mounting the plurality of battery cells (e.g., the cell array 112) to the cell mounting plate 104 within the enclosure 106.

At a step 308, the method 300 may also include mounting the temperature sensing structure 116 within the enclosure 106, wherein the temperature sensing structure 116 has one or more branches (e.g., the branches 232-236) extending between respective battery cells of the plurality of battery cells.

At a step 310, the method 300 may also include mounting the current collector 120 to the plurality of battery cells, opposite the cell mounting plate 104.

At a step 312, the method 300 may also include mounting the cover 122 to the housing 102 such that the venting chamber 264 is formed between the plurality of battery cells and an interior surface of the cover 122, wherein gas generated by the respective battery cells of the plurality of battery cells is provided to the venting chamber 264.

The method 300 can further include other steps to assemble the battery module 100 as described throughout herein.

The detailed description above describes various features and operations of the disclosed systems with reference to the accompanying figures. The illustrative implementations described herein are not meant to be limiting. Certain aspects of the disclosed systems can be arranged and combined in a wide variety of different configurations, all of which are contemplated herein.

Further, unless context suggests otherwise, the features illustrated in each of the figures may be used in combination with one another. Thus, the figures should be generally viewed as component aspects of one or more overall implementations, with the understanding that not all illustrated features are necessary for each implementation.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

Further, devices or systems may be used or configured to perform functions presented in the figures. In some instances, components of the devices and/or systems may be configured to perform the functions such that the components are actually configured and structured (with hardware and/or software) to enable such performance. In other examples, components of the devices and/or systems may be arranged to be adapted to, capable of, or suited for performing the functions, such as when operated in a specific manner.

By the term “substantially” or “about” it is meant that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide.

The arrangements described herein are for purposes of example only. As such, those skilled in the art will appreciate that other arrangements and other elements (e.g., machines, interfaces, operations, orders, and groupings of operations, etc.) can be used instead, and some elements may be omitted altogether according to the desired results. Further, many of the elements that are described are functional entities that may be implemented as discrete or distributed components or in conjunction with other components, in any suitable combination and location.

While various aspects and implementations have been disclosed herein, other aspects and implementations will be apparent to those skilled in the art. The various aspects and implementations disclosed herein are for purposes of illustration and are not intended to be limiting, with the true scope being indicated by the following claims, along with the full scope of equivalents to which such claims are entitled. Also, the terminology used herein is for the purpose of describing particular implementations only, and is not intended to be limiting.

Implementations of the present disclosure can thus relate to one of the enumerated example implementation (EEEs) listed below.

EEE 1 is a battery module comprising: a housing; a cell mounting plate mounted to the housing such that the housing and the cell mounting plate mounted thereto form an enclosure; a plurality of battery cells mounted and adhered to the cell mounting plate within the enclosure; a temperature sensing structure mounted within the enclosure and having one or more branches extending between respective battery cells of the plurality of battery cells; a current collector mounted to the plurality of battery cells, opposite the cell mounting plate; and a cover mounted to the housing such that a venting chamber is formed between the plurality of battery cells and an interior surface of the cover, wherein gas generated by the respective battery cells of the plurality of battery cells is provided to the venting chamber.

EEE 2 is the battery module of EEE 1, further comprising: a potting material interposed between the respective battery cells of the plurality of battery cells, such that the potting material decreases radial heat propagation between the respective battery cells.

EEE 3 is the battery module of any of EEEs 1-2, further comprising: a cell holder mounted to the plurality of battery cells, opposite the cell mounting plate, and interposed between the plurality of battery cells and the current collector.

EEE 4 is the battery module of any of EEEs 1-3, wherein the cell mounting plate comprises cooling fins formed about a perimeter of the cell mounting plate.

EEE 5 is the battery module of any of EEEs 1-4, further comprising: a coldplate mounted to the housing and interfacing with the cell mounting plate, wherein the coldplate comprises a plurality of channels formed therein to allow coolant to flow therethrough.

EEE 6 is the battery module of EEE 5, wherein the coldplate comprises: a first port configured to receive coolant; and a second port for discharging the coolant.

EEE 7 is the battery module of any of EEEs 1-6, wherein the one or more branches of the temperature sensing structure comprise a plurality of lobes that accommodate the plurality of battery cells.

EEE 8 is the battery module of any of EEEs 1-7, further comprising: a voltage sensor configured as a frame mounted to the plurality of battery cells.

EEE 9 is the battery module of any of EEEs 1-8, wherein the current collector comprises: a plurality of isolation layers; and one or more current-carrying layers respectively interposed between the plurality of isolation layers.

EEE 10 is the battery module of any of EEEs 1-9, wherein the cover comprises one or more burst plates configured to rupture when gas pressure level within the venting chamber exceeds a threshold value to vent gas from the battery module.

EEE 11 is the battery module of any of EEEs 1-10, further comprising: a positive electric conductor mounted to an exterior of the housing and electrically coupled to the current collector; and a negative electric conductor mounted to the exterior of the housing and electrically coupled to the current collector.

EEE 12 is the battery module of any of EEEs 1-11, wherein respective battery cells of the plurality of battery cells are cylindrical in shape.

EEE 13 is the battery module of EEE 12, wherein branches of the temperature sensing structure zigzag to accommodate cylindrical shape of respective cells of the plurality of battery cells.

EEE 14 is a method for assembling the battery module of any of EEEs 1-13. For example, the method comprises: providing a housing of the battery module; mounting a cell mounting plate to the housing such that the housing and the cell mounting plate mounted thereto form an enclosure; mounting a plurality of battery cells to the cell mounting plate within the enclosure; mounting a temperature sensing structure within the enclosure, wherein the temperature sensing structure has one or more branches extending between respective battery cells of the plurality of battery cells; mounting a current collector to the plurality of battery cells, opposite the cell mounting plate; and mounting a cover to the housing such that a venting chamber is formed between the plurality of battery cells and an interior surface of the cover, wherein gas generated by the respective battery cells of the plurality of battery cells is provided to the venting chamber.

EEE 15 is the method of EEE 14, further comprising: filling space between the respective battery cells with a potting material, wherein the potting material decreases radial heat propagation between the respective battery cells.

EEE 16 is the method of any of EEEs 14-15, further comprising: mounting a cell holder to the plurality of battery cells, opposite the cell mounting plate, such that the cell holder is interposed between the plurality of battery cells and the current collector.

EEE 17 is the method of EEE 16, wherein respective battery cells of the plurality of battery cells are cylindrical in shape, and wherein mounting the cell holder to the plurality of battery cells comprises: mounting the cell holder to respective shoulders at respective negative terminals of the plurality of battery cells.

EEE 18 is the method of any of EEEs 14-17, further comprising: positioning a voltage sensor configured as a frame within the housing.

EEE 19 is the method of any of EEEs 14-18, further comprising: mounting a positive electric conductor to an exterior of the housing, such that the positive electric conductor is electrically coupled to the current collector; and mounting a negative electric conductor to the exterior of the housing, such that the negative electric conductor is electrically coupled to the current collector.

EEE 20 is the battery module of any of EEEs 14-19, wherein the cover comprises one or more windows, and wherein the method further comprise: mounting respective burst members to one or more windows of the cover, wherein the respective burst members are configured to rupture when gas pressure level within the venting chamber exceeds a threshold value to vent gas from the battery module.

What is claimed is:

1. A battery module comprising:
a housing;
a cell mounting plate mounted to the housing such that the housing and the cell mounting plate mounted thereto form an enclosure;
a plurality of battery cells mounted and adhered to the cell mounting plate within the enclosure;
a temperature sensing structure mounted within the enclosure and having one or more branches extending between respective battery cells of the plurality of battery cells;
a current collector mounted to the plurality of battery cells, opposite the cell mounting plate; and
a cover mounted to the housing such that a venting chamber is formed between the plurality of battery cells and an interior surface of the cover, wherein gas generated by the respective battery cells of the plurality of battery cells is provided to the venting chamber.

2. The battery module of claim 1, further comprising:
a potting material interposed between the respective battery cells of the plurality of battery cells, such that the potting material decreases radial heat propagation between the respective battery cells.

3. The battery module of claim 1, further comprising:
a cell holder mounted to the plurality of battery cells, opposite the cell mounting plate, and interposed between the plurality of battery cells and the current collector.

4. The battery module of claim 1, wherein the cell mounting plate comprises cooling fins formed about a perimeter of the cell mounting plate.

5. The battery module of claim 1, further comprising:
a coldplate mounted to the housing and interfacing with the cell mounting plate, wherein the coldplate comprises a plurality of channels formed therein to allow coolant to flow therethrough.

6. The battery module of claim 5, wherein the coldplate comprises:
a first port configured to receive coolant; and
a second port for discharging the coolant.

7. The battery module of claim 1, wherein the one or more branches of the temperature sensing structure comprise a plurality of lobes that accommodate the plurality of battery cells.

8. The battery module of claim 1, further comprising:
a voltage sensor configured as a frame mounted to the plurality of battery cells.

9. The battery module of claim 1, wherein the current collector comprises:
a plurality of isolation layers; and
one or more current-carrying layers respectively interposed between the plurality of isolation layers.

10. The battery module of claim 1, wherein the cover comprises one or more burst plates configured to rupture when gas pressure level within the venting chamber exceeds a threshold value to vent gas from the battery module.

11. The battery module of claim 1, further comprising:
a positive electric conductor mounted to an exterior of the housing and electrically coupled to the current collector; and
a negative electric conductor mounted to the exterior of the housing and electrically coupled to the current collector.

12. The battery module of claim 1, wherein respective battery cells of the plurality of battery cells are cylindrical in shape.

13. The battery module of claim 12, wherein branches of the temperature sensing structure zigzag to accommodate cylindrical shape of respective cells of the plurality of battery cells.

14. A method for assembling a battery module, the method comprising:
providing a housing of the battery module;
mounting a cell mounting plate to the housing such that the housing and the cell mounting plate mounted thereto form an enclosure;
mounting a plurality of battery cells to the cell mounting plate within the enclosure;
mounting a temperature sensing structure within the enclosure, wherein the temperature sensing structure has one or more branches extending between respective battery cells of the plurality of battery cells;
mounting a current collector to the plurality of battery cells, opposite the cell mounting plate; and
mounting a cover to the housing such that a venting chamber is formed between the plurality of battery cells and an interior surface of the cover, wherein gas generated by the respective battery cells of the plurality of battery cells is provided to the venting chamber.

15. The method of claim 14, further comprising:
filling space between the respective battery cells with a potting material, wherein the potting material decreases radial heat propagation between the respective battery cells.

16. The method of claim 14, further comprising:
mounting a cell holder to the plurality of battery cells, opposite the cell mounting plate, such that the cell holder is interposed between the plurality of battery cells and the current collector.

17. The method of claim 16, wherein respective battery cells of the plurality of battery cells are cylindrical in shape, and wherein mounting the cell holder to the plurality of battery cells comprises:
mounting the cell holder to respective shoulders at respective negative terminals of the plurality of battery cells.

18. The method of claim 14, further comprising:
positioning a voltage sensor configured as a frame within the housing.

19. The method of claim 14, further comprising:
mounting a positive electric conductor to an exterior of the housing, such that the positive electric conductor is electrically coupled to the current collector; and
mounting a negative electric conductor to the exterior of the housing, such that the negative electric conductor is electrically coupled to the current collector.

20. The battery module of claim 14, wherein the cover comprises one or more windows, and wherein the method further comprise:
mounting respective burst members to one or more windows of the cover, wherein the respective burst members are configured to rupture when gas pressure level within the venting chamber exceeds a threshold value to vent gas from the battery module.
